(19) United States
(12) Patent Application Publication
(10) Pub. No.: US 2018/0032703 A1
(43) Pub. Date: Feb. 1, 2018

(54) SYSTEM FOR PERFORMING A CLINICAL TRIAL

(71) Applicant: Heike ROEDER, Duesseldorf (DE)

(72) Inventor: Heike ROEDER, Duesseldorf (DE)

(21) Appl. No.: 15/662,752

(22) Filed: Jul. 28, 2017

(30) Foreign Application Priority Data
Jul. 29, 2016 (DE) 20 2016 104 186.4

(51) Int. Cl. G06F 19/00; G06Q 10/10; G06Q 50/24

(52) U.S. Cl. CPC G06F 19/363; G06Q 50/24; G06Q 10/10; G06F 19/322

(57) ABSTRACT

An apparatus for assisting a user in establishing a record of a clinical trial is disclosed. The apparatus has: a receiving device for receiving data and/or process elements as a basis for the clinical trial; and a processor, which is configured to establish the record on the basis of the data and/or process elements and to thereby administer trial-specific data and/or process elements separately from trial-independent or generalized data and/or process elements. Also disclosed are a computer-readable storage medium storing a program, and a software program, for assisting a user in establishing a record of a clinical trial.

### CROSS-REFERENCE TO RELATED APPLICATIONS

This application claims the benefit of the filing date of the German Utility Patent Application No. DE 20 2016 104 186.4 filed on Jul. 29, 2016, the disclosure of which is hereby incorporated herein by reference

### FIELD OF THE INVENTION

The invention relates to an apparatus for assisting a user in establishing a record of a clinical trial, a computer-readable storage medium and a software program.

### TECHNOLOGICAL BACKGROUND

A clinical trial is one form of an investigation (or ascertainment) in the evidence-based medical science and clinical research. It is performed with patients or healthy test persons, and is a prerequisite for the regulatory drug approval (or . . . marketing approval).

The aim of a clinical trial is to check out drugs, particular forms of treatment, medical interventions, or medical devices in respect of their efficacy (or effectiveness) and safety. Clinical trials are performed in order to answer scientific questions and to improve the medical treatment.

The first application of a promising medical treatment [practised] on humans should thus be a clinical trial having the objective to test the efficacy and tolerability of new therapies. Such a one can however take place only, if sufficient data for a safe execution are available and a positive vote of the ethics committee concerned is on hand. In order to minimize extrinsic disturbing influences, such trials are conducted in a controlled environment.

The effort in terms of resources and time in relation to the establishment of clinical test records during the execution of a clinical trial is immense. Furthermore, due to the high complexity of a clinical trial, its error- free execution can often not be guaranteed with sufficient reliability.

### SUMMARY OF THE INVENTION

There may be a need to enable an execution of a clinical trial in a manner that is resources-conserving and robust against errors.

According to an embodiment example of the present invention, there is established an apparatus for assisting a user in establishing a record (or journal, or log) of a clinical trial, wherein the apparatus has a receiving device for receiving data and/or process elements as a basis for the clinical trial, and a processor, which is configured to establish the record on the basis of the data and/or the process elements and to thereby administer (or manage) (in particular to involve in the establishing of the record) trial-specific data and/or process elements separately or independently from trial-independent (or generalized) data and/or process elements.

According to a further embodiment example of the present invention, there is provided a method for assisting a user in establishing a record of a clinical trial, wherein in the method, data and/or process elements are input and/or received as a basis for the clinical trial, and the record is established on the basis of the data and/or the process elements, wherein in the establishing trial-specific data and/or process elements are administered separately from trial-independent (or generalized) data and/or process elements.

In a computer-readable storage medium according to an embodiment example of the present invention, a program for assisting a user in establishing a record of a clinical trial is stored, which program comprises and/or executes the method steps described above, if it is executed by one or plural processors (or data processing installation).

A software program (for example formed by one or plural computer program elements) according to an embodiment example of the present invention for assisting a user in establishing a record of a clinical trial comprises the method steps described above (and/or executes these or controls these), if it is executed by one or plural processors (or data processing installation).

Embodiment examples of the present invention can be realized both by a computer program, that is a software, and by one or plural special electronic circuitries, that is in hardware, or in arbitrary hybrid form, that is by software components and hardware components.

In the context of this application, the term “data” may be understood to be in particular a set of information elements (in particular in the form of parameter values and/or in numerical form), which may form a basis for the clinical trial and/or incurs during the same. In the context of a clinical trial, for example informations about test persons, doctor and/or amount of administered drugs and/or active pharmaceutical ingredient, recorded physiological parameters (for example blood test results) may count to such data.

In the context of this application, the term “process elements” may be understood to be in particular elements of an algorithm and/or of a process or a process sequence, which may be indicative for the execution of the clinical trial. Parameters, the values of which may be characterized by the data, can be part of these process elements. In particular, such process elements may define process steps used for the process control, which process steps may comprise a sequentialization of the process steps as well as the context and degree of detailing of the associated visualization of the contents as well as may comprise the separation instructions between generic data and individual/project data as well as may control the class affiliation of a multi-step access mechanism.

In the context of this application, the term “record (or journal, or log) of a clinical trial” may be understood to be in particular a documentation of the execution of the clinical trial, which may describe reproducibly the execution of the clinical trial in an objectified manner. Thus, the record of the clinical trial may serve as a guideline for a replication of the clinical trial.

In the context of this application, the term “trial-specific” may be understood in particular to be a specific individual relationship to the executed clinical trial. Trial-specific data and/or process elements may thus be different for different trials, because they relate just to the individualized clinical character (or essence) of the trial. For the example of a clinical trial on a novel drug, examples of trial-specific data may be the novel active pharmaceutical ingredient of the drug and/or the administered amount of the active pharmaceutical ingredient. Examples of trial-specific process elements may be the manner of the administering (or presentation) (for example the administering of the drug in the morning, at noon and in the evening, in each case after the meals).

In the context of this application, the term “trial-independent” may be understood to be in particular a missing individual relationship to the executed clinical trial. Trial-independent data and/or process elements may thus be the same for different trials. Examples of trial-independent data and/or process elements may be the involvement of an ethics committee in the clinical trial, principles of the data collection as well as safety measures.

In the context of this application, the term “processor” may be understood to be a device having a processor resource, which may be configured for—in particular concerning programming measures—processing the provided data and/or process elements based on predetermined algorithms and which may establish and/or determines the test record based on this processing. During this processing, the processor resource may be coupled capably to communicate uni-directionally or preferably bi-directionally to a data storage resource, in order to read data from the same and/or to store data on the same. The apparatus may be implemented, for example, as a computer and/or a processor, or as a plurality of co-operating computers or processors (which may be arranged spatially close to each other or spatially separated from each other).

According to an embodiment example of the present invention, there may be established a system for automated quality improvement of trials (or investigations). In particular, such a system may be implemented as an apparatus for establishing records (or journals, or logs) (in particular of clinical records), by which the individual (also referred to as trial-specific and/or trial-related) data and/or process elements, which are relevant for the particular trial, can be processed and/or administered and/or controlled separately from the generalized and/or generally accepted (also referred to as trial-independent) data and/or process elements. Demonstratively, due to this separation between trial-specific and trial-independent data and/or process elements, a separation of structure and contents of the clinical trial may be possible. A user, who may conduct, for example, such a clinical trial, may concentrate on the trial-specific contents due to the automated separated treatment of data and process elements, and may, at the same time, be released by the system from the necessity to burden his expertise with always same generalized and/or trial-independent tasks. By this separation of tasks, the trial-specific tasks, which may require a clinical (in particular medical) expertise of the user, may be separated from the structural and/or formalistic elements, which may be administered, handled or accomplished automatedly by the apparatus. By a user, who may conduct a clinical trial, being able to concentrate on the contents and not the structure of the establishing of the test record, corresponding resources can be used more efficiently and more robust against errors. Stated differently, the degree of multitasking capability that may be required by a conductor (or leader) of a clinical trial or by another user may be reduced, which may reduce the error-proneness in the sensible clinical environment.

In the following, additional exemplary embodiment examples of the apparatus, the method, the computer-readable storage medium and the software program are described.

According to an exemplary embodiment example, the processor (or apparatus) may be configured to perform the administering of the trial-specific data and/or process elements with involvement of the user. A user may input data, process elements and/or control commands via the receiving device and/or via an input/output interface, in order to adjust the establishing of the trial record. This may, however, be limited by the apparatus in order to make impossible, for example, that processes which are relevant for the safety are circumvented or modified. The participation of the user may be limited to the trial-specific data, in order to avoid that mandatory framework conditions are circumvented.

According to an exemplary embodiment example, the processor (or apparatus) may be configured to perform the administering of the trial-independent data and/or process elements without participation of the user. In this manner, a user can be released from structure-relevant tasks and may concentrate on the trial-specific tasks, which may be mapped (or represented) by the trial-specific data and/or process elements.

According to an exemplary embodiment example, the record may be a clinical record. Herein, a clinical trial may be understood to be an evidence-based investigation for testing a medical intervention on humans, which may be executed in a controlled environment subject to parameters that have been determined in advance. These parameters may be described in the clinical test record. In clinical trials, the above-mentioned advantages of the error-robust and efficient establishing of a test record may come to the fore particularly pronounced. However, exemplary embodiment examples of the invention may not be limited to clinical trials and may generally concern arbitrary studies in pharmacology (which may comprise in particular also studies for the production of drugs, in vitro studies, studies in the framework of veterinary medicine, preparations of inspections, etc.). Although predominantly clinical trials in pharmacology are described as embodiment examples in the framework of this application, also whole application areas can be served according to exemplary embodiment examples of the invention, such as the fields of activity of the health professionals, mathematicians, biologists, genetic engineers, and so forth.

According to an exemplary embodiment example, the apparatus may have an access control device, which may be configured to control (in particular to admit or to refuse totally or partially) a user access to the data and/or process elements, in particular to the trial-independent data and/or process elements (further particularly based on user properties as well as a classification of the associated data and/or process elements). Thus, in particular the generalized contents (or data) and/or process elements can be protected against unauthorized change at the usage site by [means of] access protection.

According to an exemplary embodiment example, the access control device may be configured to subject a user access to the trial-independent data and/or process elements to an access protection against unauthorized changing. For example, a modification of the trial-independent data and/or process elements may be refused totally, insofar as these are considered compulsory for the execution of the trial.

According to an exemplary embodiment example, the access control device may be configured to control the user access based on user-specific access authorization profiles. Thus, a profile, which may assign to, or may refuse for, the respective user, as a function of the capabilities, the position and/or another property of the user, the possibility to change particular data and/or process elements can be assigned to each user of a group of authorized users of the apparatus. This may increase the operational safety of the system.

According to an exemplary embodiment example, the access control device may be configured to control the user access in respect of the trial-specific data and in respect of the trial-independent data based on different user-specific access authorization profiles. For example, the generalized contents (or data) and/or process elements may be modified by another group of users as compared to the individual contents (or data) and/or process elements. Preferably, the generalized contents and/or process elements may be changed by a superordinate body (i.e. by a superordinate user, who may also be an institution or a device). It is may particularly be preferred, that this superordinate body is resident outside of and/or independent from the functional sphere of influence, to which the group of users, who may be allowed to change the individual data, may be subordinate. The operational safety may be further increased by such separated access rights.

According to an exemplary embodiment example, the receiving device may be configured for encryptedly receiving the data and/or process elements and for decrypting the received data and/or process elements. The generalized contents (or data) and/or process elements may thus be protected on a transmission path by a cryptographic method. The risk of manipulations, for example by an external hacker attack, may thereby be reduced.

According to an exemplary embodiment example, the apparatus may have an assessment device, which may be configured for establishing an assessment of the trial, the record and/or the process of the establishment of the record, in particular on the basis of at least one predetermined quality criterion. According to such an embodiment example, automated assessments and/or quality indications may be determined. In particular, herein, the compatibility of the actual execution of the clinical trial with target requirements for executing a clinical trial may serve as a quality criterion. For example, a high quality assessment may be granted only if at least a predetermined proportion (for example at least 90% or even 100%) of safety requirements and/or quality requirements (for example a double-blind test, in which neither a doctor nor patients may know which group of patients may have been administered an active pharmaceutical ingredient and which not) may be satisfied by the clinical trial. In this manner, it may be apparent objectifiedly at first glance with the help of the quality assessment, how reliable the result of the clinical trial is.

According to an exemplary embodiment example, the apparatus may have a configuration device, which may be configured to configure an output of the established record based on at least one predetermined configuration criterion. In particular, the configuration device may be configured to use as the configuration criterion at least one from the group, which may consist of:

at least a part of the received data and/or process elements, a user input, and a specification (or prescription) by the processor. Thus, the degree of the presentation of the information may be controlled by the system and/or by the generated data and/or by the configuration and/or by the process elements and/or by the user. This may allow a high flexibility and a high user-friendliness, without jeopardizing the operational safety.

According to an exemplary embodiment example, the apparatus may have a communication interface (which operates, for example, wirelessly or wire-bound) for communicating with a user via a communication network (for example the Internet, an Intranet, or a mobile communication network), in particular for receiving at least one from the group, which may consist of: data and/or process elements, and a control command for controlling the processor. In this manner, the system can be administered (or managed) remotely and/or operated remotely. By such a coupling that may be capable to communicate it may also be possible to couple external simulation systems to the apparatus.

According to an exemplary embodiment example, the apparatus may have a visualization device for visualizing an information in relation to at least a part of the data and/or process elements. For example, the information may be displayed optically on a display device (for example, a liquid crystal display device), in order to make it aware intuitively to a user. Thus, it may be possible for a user to capture the presented information in respect of data and/or process elements, and to use these insights as a basis for a user contribution for establishing the test record.

According to an exemplary embodiment example, the visualization device may be configured for visualizing at least one of the group, which may consist of: a relevance of at least one of the data and/or process elements in respect of the establishment of the record, and a uniform presentation of the data and/or process elements. For example, at least one data or process element belonging to the trial may be visualized in a process-relevant representation. This may be effected preferably with a location-dependent positioning in relation to the value added chain and/or the degree of detailing. It may also be possible that the individual and the generic data and/or process elements are visualized in a uniform representation.

According to an exemplary embodiment example, the trial-independent data and/or process elements may have been checked (or verified) already prior to the commencement (or start) of the establishing of the record, in particular checked and/or approved by a regulatory authority. The generalized contents (or data) and/or process elements may thus be checked and/or approbated in particular already prior to the supplementation of the individual parts. In this connection, it may be particularly preferable that parts of these generic elements are checked (or verified) and/or approbated by a regulatory authority.

According to an exemplary embodiment example, the apparatus may have a data base, in which data and/or process elements may be stored, in particular the trial-independent or generalized data and/or process elements. The processor may access this data base, for example in order to access the trial-independent or generalized data and/or process elements as a basis for the establishment of the record.

According to an exemplary embodiment example, the data and/or process elements may contain a regulatory data basis, in particular a dynamically variable regulatory data basis. In such an embodiment, the anchorage of the data contents and process elements to the regulatory basis as a part of the data can be carried along. Thereby, it can be controlled selectively, whether a thus configured subsystem adapts possibly always to the changes of the standing orders (or formalities) (for example governmental standing orders), or whether a context that is protected against regulatory changes arises for a respective trial (demonstratively, for example, a freezing in of all process elements, except for the concrete contents, until the end of the trial). Differentiated intermediate degrees may be possible therebetween.

According to an exemplary embodiment example, the apparatus may be implemented as a data processing installation. For example, the apparatus may be formed as a computer (for example a personal computer (PC) or a laptop), a tablet or a mobile phone. The apparatus may be a portable or a stationary apparatus.

### BRIEF DESCRIPTION OF THE DRAWINGS

In the following, exemplary embodiment examples of the present invention are described in detail with reference to the following figure.

FIG. 1 shows an apparatus for assisting a user in establishing a record of a clinical trial, according to an exemplary embodiment example of the invention.

### DETAILED DESCRIPTION OF EXEMPLARY EMBODIMENTS

Before exemplary embodiment examples of the invention are described with reference to the figures, some general aspects of the invention shall still be explained:

In the framework of scientific trials (or investigations) in the area of pharmacology, the requirements to the form and the processes may increase continuously. This may result in the complexity of trials, in particular clinical trials, increasing continuously.

Thus, the clinical record of a clinical trial may comprise in particular the following elements (by way of example):
general description of the rationale for the specific trial
summary from preceding trials
indication and drug
objectives to be investigated
statistically relevant end points
design of the trial
population (in particular inclusion and exclusion criteria)
course of the trial, ward rounds
investigations
safety aspects/side effects
drug, pharmaceutical form, packaging
statistical parameter
trial committees
data acquisition, data use
inspections
end of the trial
ethics committees
various further aspects such as abbreviations, references, appendices, and so forth.

Nowadays, the complexity of the described processes cannot be encountered satisfactorily. The presently used systems may be based on individual auxiliary releases, and the respective process elements may not be approved separately. Furthermore, there may be no cross-company generical contents available, and there may be no cyclic supplementation of these contents for the concerned establishers of trials. Each leader of a clinical trial may have his individual writing sovereignty, which may mean that a resulting clinical record must still be approved and/or approbated as a whole.

Meanwhile, the pharmaceutical research may be faced in particular with the following additional challenges:
an increasingly narrowing field for new indications pushes the research into niche indications, because good, but meanwhile already generic drugs for the populace is available on the market
increased regulatory requirements
increased complexity of designs of clinical trials
increased health economic pressure.

This may result in that significantly increased cost for research and development on the one hand, and an ever lower probability of success to be approved and/or to be reimbursed the cost for the research and development later by regulated prices on the other hand, may continuously complicate the pharmaceutical research. These interrelations may increase the pressure in the pharmaceutical research to more efficiency in the research, wherein lower cost and faster processing times may be strived for in this respect.

These and other challenges may be encountered by an apparatus according to an exemplary embodiment example of the invention, which may improve the quality, the reliability, and the establishing efficiency of trials. Thereby, in particular the mentioned risks of the admission (or approval) may decline.

Often, companies may become a part of a company acquisition (or company buy) or of a transfer of a company (or company sale). Herein, independent indications about the quality and the probability of success of a running trial may generally be missing. Conventionally, these statements may at least be determined neither self-acting and at the same time reliably, nor may they have the required independency.

According to an exemplary embodiment example of the invention, an apparatus (which may for example be realized by a data processing installation) may be established, which may isolate and/or release (and thereby relieve) the responsibles of the trial from generalizable tasks and contents in the framework of the establishment of trials, as well as structures and organizes (i.e. demonstratively may enable an advantageous separation of form and contents) nowadays very complex processes that may be necessary for the establishing and the filing of a trial in a predetermined (if applicable, changeable as a function of the contents) sequence. Furthermore, by an apparatus according to an embodiment example of the invention, repeating routine activities may be kept away from the user, and, by cyclic (if applicable, periodical) external actualizations (for example, data supplementations, updates of the process elements, and so forth), the changing regulatory requirements may be kept up to date at least in respect of the processes and generic trial elements. By suitable implementations of an apparatus according to an embodiment example of the invention it may be possible to perform such actualizations (or updates) cross-company and cross-platform with a high safeness against false and data manipulations.

Furthermore, by an apparatus according to an embodiment example of the invention, an unbundling of regulatory procedural instructions (for example complex textual instructions, how a trial is to be made at all, framework and boundary conditions, side provisions, general operation methods, form elements of the clinical record, and so forth) and the proper contents of the trial (that, which concerns the respective pharmacologically active component, contents elements of the clinical record) may be performed.

In particular, an apparatus according to an embodiment example of the invention may admit fixed processes and sequences on the one hand, while on the other hand, the contents that may be relevant for the respective trial may be changeable by the one or the plural authorized user(s).

By an apparatus according to an exemplary embodiment example of the invention, the different functional significances of the process elements can be controlled differentiatedly, and thus a reduction of the complexity may be achieved.

Thereby, it may be made possible that individual areas (or scopes) are pre-fabricated and are pre-checked or even completely validated for aspects that are related to the process as well as in relation to content-qualitativeness. Thereby, an increased total quality of the trial can be achieved, because medically dangerous errors ranging from a simple forgetting to a wrong interpretation of regulatory sequences can be prevented or at least strongly suppressed. In particular, in this manner, one can react very quickly and, due to the generalization, across-the-board (or overall) to a change of regulatory requirements. In the pharma industry, each day of delay of a market admission may mean a significant loss of sales volumes—in this respect, already moderate improvements of trial qualities may manifest a prominent economic advantage.

By the described separation between trial-specific and trial-independent data and/or process elements, the generic part as well as those parts, which may describe generic processes and sequences, may be established by specialists, and thus these contents may be designed most superiorly in respect of quality in the sense of “Best Practice”. At least these parts of the trial and/or of the clinical record may be approbated in advance and thus may be available to the users in a verified manner by a distribution mechanism.

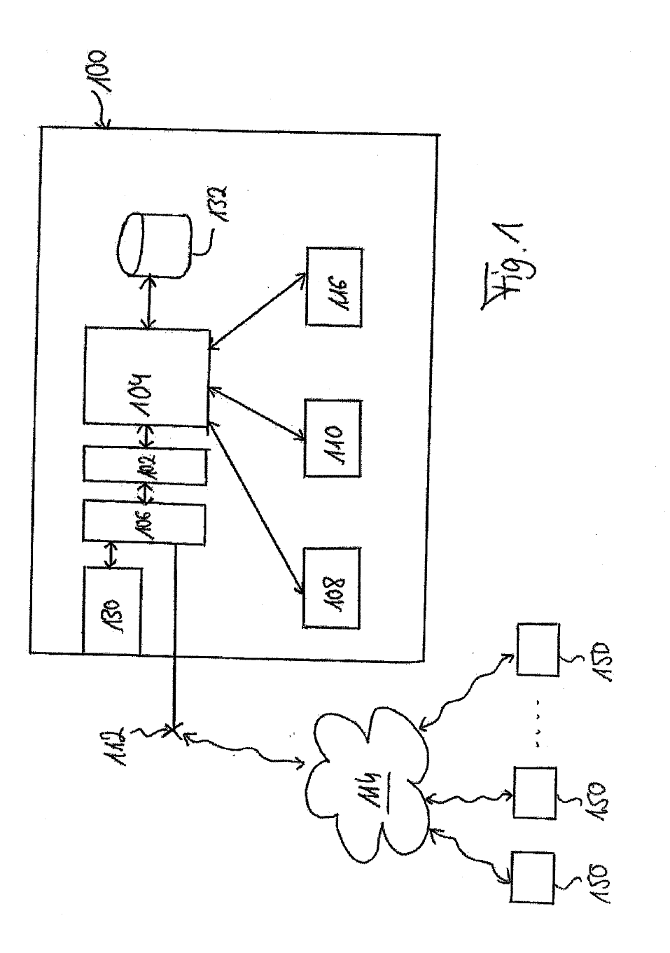

FIG. 1 shows a computer-implemented apparatus 100 for assisting a human user, which is not depicted in the figure, in the establishment of a clinical record of a clinical trial (as an example of a trial) according to an exemplary embodiment example of the invention. The apparatus 100 may be coupled capably to communicate with further nodes 150 in the framework of a communication network 114. The further nodes 150 may be other computers or the like, which may be run and/or operated by users of and/or participants in a clinical trial. In the example shown, the communication network 114 may be the Internet. The apparatus 100 as well as the further nodes 150 may be connected with each other capably to communicate wirelessly via the communication network 114. For this purpose, the apparatus 100 may have a communication interface 112 for wirelessly communicating via the communication network 114. Thereby, it may be possible to transmit data, process elements, control commands for controlling the processor 104, and so forth. The communication can be uni-directional or bi-directional.

The apparatus 100, which may be formed as a data processing installation in the embodiment example shown, may serve to assist one or plural users in establishing a preferably electronic record (or journal, or log) of a clinical trial that has just been (or is just being) performed. Such an electronic record may be a file (or plural files), in which the sequence (or course) and the result of the trial may be described in a reproducible manner and on the basis of scientific standards.

The apparatus 100 may have a receiving device 102 for receiving data and/or process elements as a basis for the clinical trial. The receiving device 102, which may be formed, for example, as a processor or as a part of a processor, may thus accept data and/or process elements, which a user may input, for example, via an input/output interface 130 of the apparatus 100 and/or may have got transmitted via the communication interface 112. The data may describe, for example, an amount of active pharmaceutical ingredient that may have been administered to particular test persons. The process elements may describe, for example, a sequence (or course) of the clinical trial and/or of the process of the establishment of the clinical record. For example, trial-independent data and/or process elements may have been checked (or verified) and validated already prior to the commencement of the establishment of the record by a governmental regulatory authority. It may be possible that the data and/or process elements may contain a dynamically variable regulatory data basis. If the regulations change, then also the corresponding data and/or process elements may be changed and/or adapted dynamically, such that an established clinical trial may always reflect the current regulations. Alternatively, the data and/or process elements may contain a static regulatory data basis.

In order to increase the data security, the receiving device 102 may be configured for encryptedly receiving the data and/or process elements and for decrypting the received (and/or for encrypting sent) data and/or process elements. By cryptography it may thereby be prevented that unauthorized bodies may obtain access to the data and/or process elements and/or may even be able to change them unauthorizedly.

A processor 104 of the apparatus 100 may be configured to establish the clinical record in total or partially on the basis of the data and/or process elements, and/or to play a part in this with a participation of a user. In connection with its mode of operation, the processor 104 may have a write and/or read access to a data base 132, in which data, process elements and/or other information may be stored temporarily or permanently. The data base 132 may be formed for example as an electronic mass storage device (for example as a hard disk). Preferably, the processor 104 may analyze the data and/or process elements, which may have been supplied by the one or the plural user(s) and/or from the data base 132, as to their contents, and administer, as a basis for the establishing of the clinical record, trial-specific data and/or process elements separately from trial-independent data and/or process elements. The processor 104, which may also be referred to as a control device for controlling the establishing of the clinical record, thus may separate data and/or process elements, based on one or plural predetermined criteria, to the effect whether these are related specifically and/or individualized for the present clinical trial, or have as their subject general framework conditions, which may not be more specific for the present clinical trial than for other clinical trials. By this separation of trial-specific and trial-independent data and process elements from each other, a user may be released from a self-acting handling of trial-independent data and process elements. In particular, only a user intervention in relation to the trial-specific data and process elements may be admitted. In other words, an unchangeable basic structure of the clinical record may remain free from a user intervention, whereas the trial-specific information may have to be provided by a user. Thereby, the resource “human” may be employed more efficiently and more robust against errors, and standard tasks may be completed by the processor resources of the apparatus 100.

Thus, the processor 104 may be configured to perform the administering of the trial-specific data and/or process elements with a participation of the user. In addition to this, the processor may further be configured to perform the administering of the trial-independent data and/or process elements without a participation of the user.

The apparatus 100 may further have an access control device 106, which may be configured to control a user access to the data and/or the process elements. Thus, it may be possible in particular to prevent an access to the particularly sensible trial-independent data and/or process elements, and thereby to avoid, for example, a circumvention of mandatory provisions (or regulations). The access control device 106 may be in particular configured to subject a user access to the trial-independent data and/or process elements to an access protection against unauthorized changing. For this purpose, the access control device 106 may control the user access based on user-specific access authorization profiles. In other words, an access authorization profile may be assigned to each user, which profile may determine, which measures may be performed by a particular user (for example only reading, only writing, reading and writing, and namely in relation to trial-specific data and/or process elements and/or trial-independent data and/or process elements, respectively). By the access control device 106 being configured to control the user access in respect of the trial-specific data and in respect of the trial-independent data based on different user-specific access authorization profiles, the competences may be distributed such that an efficient protection against manipulations may be possible.

Preferably, the apparatus 100 may further have an assessment device 108, which may be realized for example as a processor or a part of a processor, and which may be configured for establishing an assessment of the process of the establishment of the record, and namely on the basis of at least one predetermined quality criterion. For example, the assessment device 108 may assess, to which degree mandatory quality prescriptions for the clinical trial have been observed, and thus may allow, by an output of a quality value by the input and/or output unit 130 and/or by a corresponding remark on the just established clinical record for a skillful user to capture at one glance, how reliable the executed clinical trial and its results are.

A configuration device 110, which may be formed, for example, also as a processor or a part of a processor, may be configured to configure an output of the established record based on at least one predetermined configuration criterion. In this connection, the configuration device 110 may be configured in particular to employ as a configuration criterion at least one from the group, which may consist of: at least a part of the received data and/or process elements, a user input, and a specification by the processor 104. Thereby, a freely configurable output of the established record may be possible, which may further increase the user-friendliness.

Advantageously, the apparatus 100 may further have a visualization device 116 for visualizing an information in relation to at least a part of the data and/or process elements. Herein, the visualization device 116 may be configured for visualizing at least one of a group, which may consist of: a relevance of at least one of the data and/or process elements in relation to the establishment of the record, and a uniform representation of the data and/or process elements. Such information may be displayed, for example, also by the input and/or output unit 130 and/or may be made a part of the established clinical record.

Due to the high sensibility of the clinical data, the receiving device 102 (which may also be formed as a receiving/transmission device) may use a cryptographic method for the distribution of the generalized data and processor elements as well as for remote accesses. The access protection on the data and process elements may be effected, for example, by an access system, which may be multi-levelled as needed, and which may contain different authorizations for read and write accesses. Herein, the detailing of the access protection may be differentiated to a high degree such that also the access to the respective type of the process elements may be controlled by this access protection.

By one embodiment example, a conductor (or leader) of a trial as a user of the apparatus 100 may be forced to an implicit compliance with regulatory prescriptions by a purposeful formalization of the processes. Thus, it may be prevented that certain parts of the clinical trial may become erroneous due to carelessness or inattentiveness or deliberate will for manipulation. In order to accomplish this, the access control device 106 may prevent the access to particular read and/or write processes. This may represent a relevant relief for the conductor of the trial. The mentioned simplification of the processes may allow a simpler workplace description for a user of the apparatus 100, and therefore may reduce the individual competence that may be required on the part of the staff. By such an embodiment, it may also be prevented that users draft own descriptions too creatively, which may not satisfy all regulatory prescriptions. According attempts of a user to modify data and/or process elements accordingly may be refused by the access control device 106.

In a further embodiment, a fulfilling or quality factor of the respective trial may be determined by qualitative and/or quantitative measurement methods of the apparatus 100 that may be formed as a data processing installation. This task may be performed, for example, self-actingly (or automatedly) or in response to a user instruction, by the assessment unit 108. Such a parameter, which may indicate the quality of a clinical trial or of the established clinical record, may have an objective statement character, if the apparatus 100, which may determine this parameter, may perform its assessment on the basis of independent sequences and processes. Manipulations of the clinical trial may thus be excluded. It may be just by the generic part of the data and/or process elements, which may be administered by the apparatus 100, that a sufficiently large independency in the assessment may be given, such that the correspondingly calculated parameters for the assessment of the quality may represent a concrete, sound and referenceable statement.

In a further embodiment, the degree of detailing of the presentation of the information may be controlled as a function of the context, controlled configurably, controlled by process elements and/or controlled in pre-configured areas by the user. Thus, an adaptation of the visualized data amount to the respective context, the progress of the trial and the respective work step may be possible. In other words: The width and depth of the presentation of the contents and process visualization may be controllable dynamically. Corresponding functions may be performed by the configuration device 110 and/or by the visualization device 116.

In a further embodiment, the course (or sequence) of the clinical trial may be controlled and/or predetermined by the implementation of an SOP (Standard Operating Procedure). Corresponding service regulations (or instructions) may be stored in the data base 132 and be executed by the processor 104. Thus, also sequence predictions as to what concerns the planning and chronological order may be possible, which predictions may obtain a comparable basis just by the generalization.

In a further embodiment, all trial components may be requested remotely and changed remotely via a standardized way (such an access from a remote position may be implemented, for example, by a gateway). Such a remote request and/or remote control may be enabled by the communication interface 112, which may enable a communication of the apparatus 100 via the communication network 114. This may also allow to integrate local or cloud-based simulation models. Because such simulation models may be implemented very computationally intensively, they may often be made available in a central service (for example, a central server, cloud service, etc.). The communication interface 112 may be implemented, so that the contents of the apparatus 100 may be coupled to such an external simulation model.

In a further embodiment, an easy navigating may be enabled for the user by an optimization of the process elements for the clinical development with assistance of a visualized, transparent process landscape, which may map (or image) the value added chain horizontally and the degree of detailing vertically, which may strongly reduce the effort for the process and/or document search as well as for the SOP. Such functions may be taken over by the visualization device 116.

In a further embodiment, the relevant process elements and the documents may be checked regulatorily as a total package. Furthermore, the apparatus 100 may be enabled with a suitable definition of the process elements, to map (or to image) a logical process landscape including a modular construction (in particular, including the possibility to filter according to responsibilities), such that individual sub-themes and sub-areas may be broken off as concerns the tasks, and may be relinquished for example to a third party (in particular external parties).

In a further embodiment, the logical process landscape may be visualized by the visualization device 116, and thereby, the interest of the staff may be fostered. By the possibility to navigate, in a user-friendly tool, through process elements, which may not belong causally to the own area of responsibility, a holistic understanding of the value added chain may be fostered and thereby the cross-functional cooperation may be supported. The mentioned form of the visualization may result in a greater acceptance of the system that may be controlled by the apparatus 100 by the implicit possibilities for simplification and the presentation of the larger relationships.

According to an exemplary embodiment example of the invention, a significantly reduced personnel expenditure may be realized by a combination of the different measures described above on the one hand, and a development time that may be reduced by several months may be realized on the other hand. The achieved reduction of the operative errors may be particularly noteworthy.

The mode of operation for establishing a record (or journal, or log) of a clinical trial according to an embodiment example of the invention may thus be as follows: A user may activate the apparatus 100 in order to generate a record for a new clinical trial. The user may input data and/or process elements, which may be trial-specific. The apparatus 100 may contribute trial-independent data and/or process elements. During the execution of the study, a user may input, or plural users may input, data and/or process elements, wherein user profiles may have to be taken into account. During the execution of the study, the apparatus 100 may handle trial-independent data and/or process elements independently from the trial-specific data and/or process elements, and may grant only a limited or no authorization at all to the users in particular for a changing of the trial-independent data. At the end of the trial, the apparatus 100 may generate the clinical record on the basis of the trial-specific and the trial-dependent data and process elements in conformity with the course of the trial, and may output the same. The quality of the clinical record may be assessed in the clinical trial and may be represented as the case may be. The communication during the process may be effected encryptedly.

Supplementarily, it should be noted that the term “having” does not exclude other elements or steps, and “a” or “an” does not exclude a plurality. Furthermore, it is to be noted that features or steps, which have been described with reference to one of the above embodiment examples, may be used also in combination with other features or steps of other embodiment examples described above. Reference signs in the claims are not be considered as a limitation.

1. Apparatus for assisting a user in establishing a record of a clinical trial, wherein the apparatus has the following:
a receiving device for receiving data and/or process elements as a basis for the clinical trial;
a processor, which is configured to establish the record on the basis of the data and/or the process elements and to thereby administer trial-specific data and/or process elements separately from trial-independent or generalized data and/or process elements.

2. Apparatus according to claim 1, wherein the processor is configured to perform the administering of the trial-specific data and/or process elements with participation of the user.

3. Apparatus according to claim 1, wherein the processor is configured to perform the administering of the trial-independent data and/or process elements without participation of the user.

4. Apparatus according to claim 1, wherein the record is a clinical record.

5. Apparatus according to claim 1, having an access control device, which is configured to control a user access to the data and/or process elements, in particular to the trial-independent data and/or process elements.

6. Apparatus according to claim 5, wherein the access control device is configured to subject a user access to the in particular trial-independent data and/or process elements to an access protection against unauthorized changing.

7. Apparatus according to claim 5, wherein the access control device is configured to control the user access based on a user-specific access authorization profile.

8. Apparatus according to claim 7, wherein the access control device is configured to control the user access in respect of the trial-specific data and in respect of the trial-independent data based on different user-specific access authorization profiles.

9. Apparatus according to claim 1, wherein the receiving device is configured for encryptedly receiving the data and/or process elements and for decrypting the received data and/or process elements.

10. Apparatus according to claim 1, having an assessment device, which is configured for establishing an assessment of the trial, of the record and/or of the process of the establishing of the record, in particular on the basis of at least one predetermined quality criterion.

11. Apparatus according to claim 1, having a configuration device, which is configured to configure an output of the established record based on at least one predetermined configuration criterion.

12. Apparatus according to claim 11, wherein the configuration device is configured to use as the configuration criterion at least one from the group, which consists of: at least a portion of the received data and/or process elements, a user input, and a specification by the processor.

13. Apparatus according to claim 1, having a communication interface for communicating with a user via communication network, in particular for receiving of at least one from the group, which consists of: data and/or process elements, and a control command for controlling the processor.

14. Apparatus according to claim 1, having a visualization device for visualizing an information in relation to at least a portion of the data and/or process elements,
wherein the visualization device is in particular configured for visualizing at least one from a group, which consists: of a relevance of at least one of the data and/or process elements in relation to the establishment of the record, and a uniform representation of the data and/or process elements.

15. Apparatus according to any one of the claims 1, wherein the trial-independent data and/or process elements have been checked already prior to the commencement of the establishment of the record, in particular checked by a regulatory authority.

16. Apparatus according to claim 1, wherein the data and/or process elements contain a regulatory data basis, in particular a dynamically variable regulatory data basis.

17. Apparatus according to claim 1, implemented as a data processing installation.

18. Apparatus according to claim 1, having a data base, in which data and/or process elements can be stored, in particular trial-independent or generalized data and/or process elements.

19. Computer-readable storage medium, in which a program for assisting a user in establishing a record of a clinical trial is stored, which program, if it is executed by a data processing installation, executes or controls the following process:
receiving data and/or process elements as a basis for the clinical trial;
establishing the record on the basis of the data and/or the process elements, wherein, in the establishing, trial-specific data and/or process elements are administered separately from trial-independent or generalized data and/or process elements.

20. Software program for assisting a user in establishing a record of a clinical trial, which software program, if it is executed on a data processing installation, executes or controls the following process:
receiving data and/or process elements as a basis for the clinical trial;
establishing the record on the basis of the data and/or process elements, wherein, in the establishing, trial-specific data and/or process elements are administered separately from trial-independent or generalized data and/or process elements.
